(19) United States
(12) Patent Application Publication
(10) Pub. No.: US 2007/0156429 A1
(43) Pub. Date: Jul. 5, 2007

(54) Online transaction related to vacation rental property

(76) Inventor: Joseph F. Godar, Cleves, OH (US)

Correspondence Address: HASSE & NESBITT LLC, 8837 CHAPEL SQUARE DRIVE, SUITE C, CINCINNATI, OH, 45249, US

(21) Appl. No.: 11/322,867

(22) Filed: Dec. 30, 2005

(51) Int. Cl. G06Q 99/00

(52) U.S. Cl. 705/1

(57) ABSTRACT

A system and method for completing an automated online transaction related to vacation rental property between an owner and a prospective rentor. Owners of vacation rental property provide information in the form of a Listing to an owner database at a website which provides access to the owner database by prospective rentors. Rentors can then select a desired Listing and book the associated property online and in real-time. Each Listing includes a rental schedule associated with a particular vacation rental home, a contract for the rentor to complete, and an application form. The website provides an interface comprising a field for the rentor to view and select at least one of the Listings and to provide personal information via the application form. A booking engine processes the completed application form, verifies that the rentor has agreed to the terms and conditions of the contract, generates an instant approval for a qualified rentor, and executes a booking with the qualified rentor.

### FIELD OF THE INVENTION

The present invention relates in general to electronic commerce, and in particular to a system and method for processing online transactions between owners and rentors of vacation rental property.

### BACKGROUND OF THE INVENTION

Currently the private owner of one or more vacation rental homes does not have the ability to provide their prospective rentors with quick, online booking of their units. While commercial services and websites do exist in which prospective rentors may access a search engine providing information about commercial real estate or rental properties, these services typically do not provide access to privately owned properties, and further do not provide a means to complete the transaction online. Typically, owners or advertisers of rental property either provide or subscribe to a website that includes an online search engine, and a prospective rentor searches the website for a desire property. However, before the transaction can be completed, the prospective rentor typically must first correspond by way of a telephone call or a separate electronic mail message with the owner, or an intermediary, before a booking of the property can be completed. Further, correspondence between rentor and owner typically requires a series of e-mails and/or telephone calls, as well as the exchange and review of one or more contracts, before the transaction is completed. Such contracts typically include application forms or information checklists which must be printed out by the rentor, completed, signed and mailed back to the owner. Each party must then sign and make copies of the forms and mail them back to each other. This often proves to be a very time consuming procedures and difficult to track.

In the crowded field of business method patents, it is generally known to provide a search engine which allows owners of real estate to advertise their properties to prospective buyers online. For example, U.S. Pat. No. 6,839,880 to Morse et al. (“the Morse patent”) discloses an electronic real property viewing system for providing virtual tours of real property units via the Internet. Affiliates or subscribers of the system, including real estate agents and property owners, take their own photographs and upload the images along with any desired data sets to the website, thereby constructing their own virtual tour, which is available immediately, or in real-time, for prospective customers to view. However, the Morse patent does not provide a method for completing a sale or rental, and also does not disclose use of its system for vacation rental properties. Similarly, U.S. Pat. No. 5,664,115 to Fraser and U.S. Pat. No. 5,032,989 to Tornetta both provide early search methods for listing real estate properties owned by sellers for prospective buyers to view, based on criteria such as price, location, size or type.

Other patents describe a “better” search engine, but do not offer a means to complete a transaction. For example, U.S. Pat. Nos. 6,671,697 and 6,839,720, both to Thibodeau, disclose a computer system and process for determining availability of vacation rental property, but provide no means for quickly completing the sale or rental of the property online.

U.S. Pat. No. 6,678,663 to Mayo (“the Mayo patent”) discloses an Internet-based commercial real estate advertising system. Advertisers (landlords) subscribe to and pay for this service, and are billed to their credit cards on a periodic basis. Landlords list one or more properties for sale or lease, and potential tenants view the listings via the system and interact with the potential landlord through electronic mail, preferably on an anonymous basis in the initial stages, before a lease transaction is completed. Published U.S. Patent Application No. 2005/0246273 to Farley (“the Farley publication”) similarly discloses a method of providing an online sale by owners of properties that can be accessed by a buyer or owner over the Internet. The method provides a database of properties for sale by the owner. An owner who subscribes to the system receives a secure log in and password, and then provides information about their properties into a database. A “listing wizard” then provides a series of online forms for both buyer and seller to fill out, and a means for the buyer and seller to communicate via email prior to completing a sale. While useful for their intended purposes, the Mayo patent and the Farley publication do not provide a system or method for real-time, online booking of a vacation rental property.

As noted above, online transactions involving real estate typically require prolonged negotiations prior to completion. However, it is generally known to provide a system and method to quickly complete an online sale in real time. For example, U.S. Pat. No. 5,732,398 to Tagawa discloses a self-service system of selling travel-related products or services by means of an interactive travel service system. The system functions as a travel agent, matching the financial situation and needs of the traveler with available choices. The user of the self-service system first provides information regarding desired travel destinations and interests, is provided a list of destinations, services and/or products to choose from, and a sale is closed. U.S. Pat. No. 6,922,676 to Alnwick discloses a system and method for ordering components over the Internet, where a website owner provides information from one or more vendors of inventory, including a home page for each of the vendors. Using the website of a particular vendor, a customer determines whether a particular component is in stock, and then requests that component. A purchase order is transmitted to at least one vendor and the buyer purchases the inventory after the purchase order is approved by one of the vendors. U.S. Pat. No. 6,684,196 to Mini et al. (“the Mini patent”) discloses a method and apparatus for facilitating online real estate transactions between a seller and a buyer. The real estate transaction may be initiated and facilitated from beginning to end largely via the Internet, thereby providing a “one-stop-shop” for home buyers to find and purchase homes, and for home sellers to list and sell their homes. While the Mini patent provides a means to carry out an online real estate transaction, the process can be time-consuming, involving real estate agents, financing, homeowner's insurance, and title insurance, all provided by a transaction manager.

While the patented inventions reviewed above may be useful for their intended purposes, there remains a need to provide a means for quickly completing an online transaction between an owner of vacation rental property and a prospective rentor. Further, it would be advantageous to provide a system and method for completing an online transaction related to rental of a vacation rental property in which a private owner of one or more vacation rental properties can advertise and rent out their property online and in real-time. It would also be advantageous to provide a prospective rentor of a private vacation rental property a means to quickly search for and book a desired vacation rental property online.

### SUMMARY OF THE INVENTION

Accordingly, the present invention provides a system and method for quickly completing an online transaction related to vacation rental property. Private owners of vacation rental homes typically subscribe to a website which provides listing information and online booking services, and prospective rentors of the vacation homes are typically able to both view and book any private property owned by one of the subscribing owners, completely online. The website can facilitate a process that begins with a search at the website by the rentor for a privately owned vacation home and is completed with a booking transaction between the rentor and the owner of the property.

More specifically, a first aspect of the invention is a system for conducting an online transaction related to vacation rental property, the system comprising (a) an owner database including a plurality of Listings, each Listing specific to a vacation rental property and comprising a rental schedule, an Offer and a contract including terms and conditions; (b) a website interface providing a field for the prospective rentor to view the Listings and an application form for a prospective rentor to complete; and (c) a booking engine adapted to receive an Acceptance from the prospective rentor, qualify the prospective rentor, and execute a booking with the qualified rentor.

A second aspect of the invention is a method for an owner of vacation rental property to advertise and rent their property online, the method comprising computer-implemented steps for (a) providing at least one Listing to a website, the website comprising an owner database, a website interface, and a booking engine; (b) receiving an electronic mail message providing notification of a booking of the at least one Listing; and (c) accepting or refusing the booking, wherein the owner database includes a plurality of Listings, each Listing specific to a vacation rental property and comprising a rental schedule, an Offer and a contract including terms and conditions; wherein the website interface provides a field for the prospective rentor to view the Listings and an application form for a prospective rentor to complete; and wherein the booking engine is adapted to receive an Acceptance from the prospective rentor, qualify the prospective rentor, and execute a booking with the qualified rentor.

A third aspect of the invention is a method for a prospective rentor of vacation rental property to book the property online, the method comprising computer-implemented steps for (a) selecting at least one Listing at a website, the website comprising an owner database, a website interface, and a booking engine; (b) providing an Acceptance to an Offer to book the at least one Listing at the website; and (c) participating in a booking with the booking engine, wherein the owner database includes a plurality of Listings, each Listing specific to a vacation rental property and comprising a rental schedule, an Offer and a contract including terms and conditions; wherein the website interface provides a field for the prospective rentor to view the Listings and an application form for the prospective rentor to complete; and wherein the booking engine is adapted to receive the Acceptance from the prospective rentor, qualify the prospective rentor, and execute a booking with the qualified rentor.

In one embodiment the website interface can direct the prospective rentor to view the plurality of Listings, select at least one of the Listings, review the rental schedule and the contract associated with the selected Listing, complete the application form, and provide an Acceptance of the Offer associated with the selected Listing. Typically the prospective rentor generates and Acceptance by clicking on an Acceptance button at the website. The booking engine can qualify the prospective rentor by confirming that the prospective rentor has satisfactorily completed an application form, has provided an Acceptance of the Offer associated with a selected Listing, and has agreed to the terms and conditions associated with the contract of the selected Listing. Typically the website interface generates a message to the qualified rentor at the website interface their status as a qualified rentor.

In one embodiment the booking engine can execute a booking by directing the qualified rentor to select a form of payment offered by the owner, completing a purchase transaction, and generating an electronic mail message to the owner and the rentor providing notification of the booking. Typically the booking engine completes the purchase transaction by processing a credit card belonging to the rentor, but can also complete the transaction by making arrangements with the rentor to pay by check or money order. Typically the owner, after receiving the e-mail message providing notification of the booking, retains the option to accept or refuse the booking for any reason. If accepted, the owner sends a reply e-mail which causes the website to generate an e-mail message to the rentor confirming the transaction, and if refused, the owner sends a reply e-mail which causes the website to generate an e-mail message to the rentor canceling the transaction.

These and other advantages and features of the invention will be apparent upon reading the following detailed description of presently preferred embodiments of the invention.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a schematic block diagram of the system of the present invention.

FIG. 2 is a schematic flow diagram of the online vacation home rental method of the present invention.

### DETAILED DESCRIPTION OF PREFERRED EMBODIMENTS

Definitions: As used herein, the term “Acceptance” shall mean acceptance of an online Offer, or an online acknowledgement of agreement to a contract, including the terms and conditions thereof, associated with a selected Listing. Online Acceptance by the rentor of the owner's Offer typically serves as a binding electronic signature.

As used herein, the term “application form” shall mean an information questionnaire for a prospective rentor to complete online. The questionnaire typically requests rentor information such as name, address, phone number, credit card information, desired dates for rental, desired rental property, number of rentors in the group, etc.

As used herein, the term “booking engine” shall mean a computer program which provides a website the ability to perform tasks relating to renting a vacation rental property associate with a selected Listing. Tasks typically include, but are not limited to, receiving an Acceptance of the offer for rental associated with a selected Listing, qualifying the prospective rentor to rent the property associated with the selected Listing, and executing a booking of the property with the rentor according to the terms and conditions of the contract.

As used herein, the term “contract” shall mean a binding agreement, enforceable by law, between an owner of a vacation rental property and a rentor of the property. An online contract is typically included with each Listing of vacation rental property, and includes the price, terms and conditions for renting the property.

As used herein, the term “field” shall mean a set of characters displayed at a website interface comprising units of information programmed by a web server.

As used herein, the term “Listing” shall mean information regarding a specific vacation rental property, typically including a rental schedule, an Offer, and an online contract specific to the vacation rental property. An owner typically provides the information for a Listing, and does so for each property owned. An owner's completion and submission of a Listing typically serves as a binding electronic signature.

As used herein, the term “Offer” shall mean a binding offer to the public to book a specific vacation rental property at a specific price and includes the fees associated with renting the property, including rental fees, taxes, security deposit and the payment schedule. An Offer is provided by the owner of the vacation rental property, and is associated with a Listing.

As used herein, the term “owner” shall mean an owner of one or more vacation rental properties who has submitted Listing information to the owner database of the system.

As used herein, the term “qualify” shall mean approving a prospective rentor, such that the rentor is permitted to rent the property associated with a Listing.

As used herein, the phrase “qualified rentor” shall mean a rentor who has satisfactorily selected at least one of the Listings, selected the desired dates of stay, reviewed the associated contract, completed the application form, agreed to the terms and conditions of the contract, and provided an Acceptance of the Offer associated with a selected Listing.

As used herein, the term “rental schedule” shall mean data related to a Listing for a specific vacation rental property, typically including displays for pictures and/or videos of the unit, and a calendar showing dates of availability.

As used herein, the phrase “terms and conditions” shall mean the prerequisites, responsibilities and/or circumstances for rental of a particular vacation rental property. The terms and conditions are typically included in an online contract for renting a vacation rental property associated with a Listing, and are typically determined by both the owner of the vacation rental property and the website hosting the owner's information.

As used herein, the term “website interface” shall mean a display or field at a computer monitor in communication with a website via a website browser.

Generally, the automated vacation rental home system and method of the present invention uses a website to receive information from both owners of vacation rental property and prospective rentors. The website uses a booking engine to process the information provided online. The booking engine reviews the information provided by the prospective rentor to make an immediate decision of approval or refusal. For example, the system can approve or refuse the prospective rentor as a qualified rentor based on information such as the number of members in the rentor's party, the dates requested for booking, the age of the members in the rentor's party, the adequacy of credit card information, etc. If the rentor is refused or rejected, the booking engine instantly generates a message for the prospective rentor indicating such refusal. If the rentor is approved, the booking engine generates and displays an instant approval message to the qualified rentor, and then automatically proceeds to book the property with the qualified rentor, on behalf of the owner.

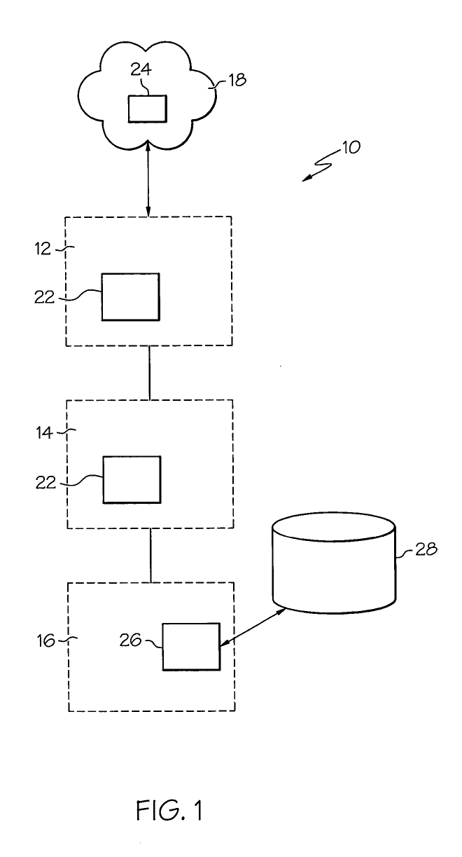

As shown in FIG. 1, the online vacation rental home system and method 10 includes a web server 12, an application server 14, and a database server 16. The web server 12 provides a web site interface 22 for the prospective rentor's web browser and is in network communication with a devoted website 24 via the Internet 18. The web server 12 is also in network communication with the application server 14. The application server 14 includes a booking engine 20 and is in network communication with the database server 16. The database server 16 is in network communication with the application server 14, and hosts interactions between the database engine 26 and the owner database 28. The database engine 26 is in network communication with the owner database 28 via the database server 16.

The system 10 allows each owner of one or more vacation rental properties to control the renting of their units by supplying information in the form of Listings, each Listing being specific to a particular rental property or unit. Owner Listings are stored in the owner database 28, which the database engine 26 can access to present unit-specific Listings and process unit-specific contracts to prospective rentors. Listing parameters are typically preconfigured, such that each owner may modify each of their Listings within the owner database 28 within the pre-set parameters. That is, each owner may edit, add and/or delete specific Listings, and control the arrangement of their Listings within the owner database 28, within the set parameters. In this manner, each owner can customize their own Listings, including any contracts and/or application forms, within the system 10. The system then processes each Listing according to each owner's preferred rental criteria. Typically the owner database 28 can be modified by an authorized owner or an authorized administrator of the website at any time, and the changes can be made effective immediately or at some future time.

The website 24 typically provides an Administration page for owners to access. The Administration page is typically one of the web pages which are available for viewing at the website 24. However, the Administration page typically is an administration tool and is not accessible by the rentors. It is typically accessible only by subscribing owners of the website and other authorized administrators. Each owner, upon subscribing to the website, is authorized to receive direct, but limited, access to the Administration page over a secure connection via the Internet 18. Through the Administration page each owner can provide Listing information specific for each of their vacation rental properties, to be stored in the owner database 28. Thus, owners can use the Administration page to customize their Listings by preparing specific application forms and defining specific qualification criteria for their units. This information is then used in the booking process, which is controlled by the booking engine 20. Submission by an owner of a Listing via the Administration page, suitable for viewing and selection by a prospective rentor, can serve as an electronic signature by the owner authorizing an Offer to the public.

Generally, the application server 14 is an “active application server.” In other words, the application server 14 supports and provides an environment for server-side logic expressed as objects, rules and components. The application server 14 resides between the web server 12 and the database server 16, and serves to process data for the web server 12 and the database server 16. In use, the web server 12 hosts dynamic web pages and provides an interface 22 for prospective rentors to interact with the application server 14 and the database server 16. The application server 14 provides the business logic for the vacation rental home system and method 10. The application server 14 synchronizes with the web server 12 for processing information provided by the prospective rentor. All information provided by the prospective rentor, typically in the form of a completed application form and/or payment questionnaire, proceeds through the web server 12, which transmits the required information to the application server 14. The application server 14 uses the booking engine to process and act on the information provided.

The booking engine 20 typically resides on the application server 14 and interacts with the database server 16. As non-limiting examples, the booking engine 20 is typically able to process completed application forms, generate instant approvals for qualified prospective rentors, and execute purchase transactions by processing credit cards. Prospective rentors of vacation rental property interact directly with the web server 12, and indirectly with the application server 14 and the database server 16, through a secure portal in a firewall via the Internet 18.

It should be noted that web servers 12 are becoming increasingly flexible, such that deployment engines such as Extensible Markup Language (XML) have blurred the lines between static web servers 12 and application servers 14. However, using an application server 14 to perform application processes can provide a number of advantages. By removing the application components from the web server 12, the workload is divided between the two servers, thereby maximizing processing efficiency. Application servers 14 can also provide network administrators with tools for managing components and runtime services, such as session management, synchronous/asynchronous prospective rentor notifications and for executing server business logic. Additionally, the application server 14 can provide a level of fault tolerance. The application server 14 provides the ability to eliminate single points of failure. Administrators can configure the application server 14 to define recovery and fail-over policies in case of a failure of one object or component. The application server 14 assists in load balancing, transaction management, and security in that it can route requests to different servers according to various parameters. Additionally, redundant application servers can be in place so as to provide fault tolerance and reroute rental requests in the event that an application server 14 fails.

The booking engine 20 and the database engine 26 may be written in any number of object-based computer languages, such as C++, Java, and the like. The application server 14 interacts with the database server 16 using any number of routable protocols, such as TCP/IP, IPX/SPX, Open Database Connectivity (ODBC) protocol, and the like. Custom scripts may also be used. The database server 16 may be implemented in any number of development environments, such as Microsoft SQL Server, Oracle Server, Sybase Server and the like. By using the same server topology for the application server 14 and the database server 16, “overhead” management is simplified because administrators of the system 10 need only familiarize themselves with a single server topology. Furthermore, transmission of data from the application server 14 to the database server 16 involves routing. To the extent that the servers are separated geographically, such transmissions involve routing through several relay points, with each relay adding a small delay. The relationship between distance and delays is not linear. A transmission delay will be greater for points which involve a change of “backbones.” For example, if a router point involves changing from a Sprint network to an MCI network, such a transition may involve a greater delay than if the switch occurred between two MCI networks. The Internet Backbone is a metaphor for the interconnectivity of Internet Service Providers (ISP). Similar to Internet backbone routing, switches within a Local Area Network (LAN) between different server topologies invoke filtering processes, and latencies may be introduced. Thus, by using the same server topologies for the application server 14 and the database server 16, filtering and routing delays are minimized. In FIG. 1, it is assumed that the web server 12, the application server 14, and the database server 16 are hosted by an ISP, such that the ISP provides a firewall (not shown) between the servers and the Internet 18.

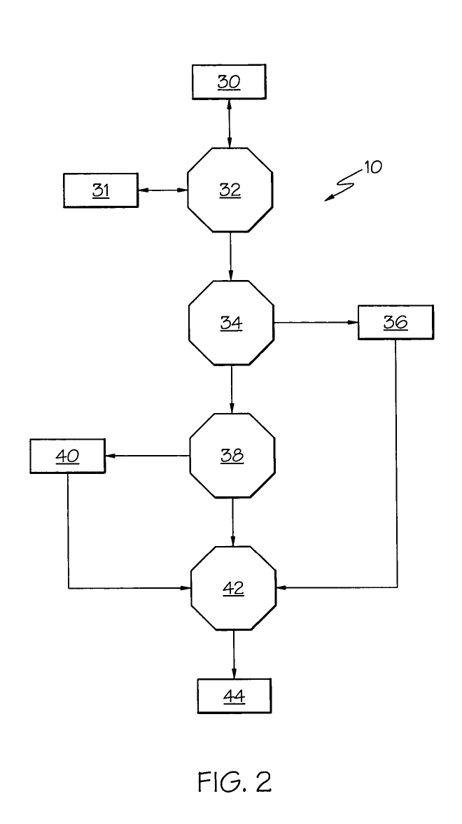

As shown in FIG. 2, the system 10 handles the entire rental process from the prospective rentor's position. The transaction proceeds as follows through a number of sequential steps. First the owner subscribes to the website and provides rental property details for each Listing of their vacation rental properties, including a rental schedule with dates and offered rates, to be included in the owner database (Step 30). Next, a prospective rentor accesses the website and searches for and selects at least one Listing within the owner database (Step 31). The booking engine then solicits and receives information from the prospective rentor regarding a selected Listing (Step 32), and then processes the submitted information, including the completed application form, and determines whether the prospective rentor is a qualified rentor (Step 34). The booking engine thereafter generates a Status message to the prospective rentor at the website interface their status (Step 36). Upon approval, the booking engine automatically executes a booking of the property associate with the selected Listing for the dates requested, and according to the terms and conditions of the contract (Step 38). Thereafter, the booking engine generates a Notification message to the owner and the rentor, confirming that a qualified rentor has booked the vacation rental property associated with the Listing (step 40). After the booking engine generates the Notification message (step 40), the owner may still decide, for any reason and at any time after the receipt of the Notification e-mail, that the qualified rentor is not (or no longer) qualified to rent the property, the owner can cancel, void or rescind the transaction (step 42). Whether or not a refund is in order will depend upon the timing and/or the reason for cancellation. Likewise, the qualified rentor, for any reason and at any time after the receipt of an approval Status message (Step 36), may cancel, void or rescind the transaction (Step 42). Whether or not the rentor will receive a refund will also depend on the reason and/or the timing of the cancellation. Any decision to cancel or rescind the transaction must be conveyed to the booking engine via the website. Upon cancellation of any transaction, the booking engine will generate a Cancellation message to both the owner and the rentor, notifying them of the cancellation (Step 44).

Regarding the step of soliciting and receiving information from the rentor (Step 32), after the prospective rentor has selected at least one of the Listings (Step 31), the booking engine typically directs the rentor to complete an application form. A typical application form for the rentor to complete can be seen in Example 1.

### EXAMPLE 1

Sample Online Application Form

[image]

After completing the application form, the rentor is directed to select the desired dates of stay. If the requested dates of stay are available, the rentor will be given an online contract to review. A typical online contract is shown below in Example 2.

### EXAMPLE 2

Sample Online Contract

### “Beach Retreat” Terms and Conditions

### Unit Number 132

### Please Print These Terms and Conditions for your Records.

The property will be ready for occupancy at 4:00 PM local time on the beginning date of Jan. 21, 2006 and must be vacated by 10:00 AM local time on Jan. 28, 2006. This is a Saturday to Saturday Rental. During high season, some units may not be ready by 4 p.m., your patience is appreciated.

The PREMISES is located at: 1234 Beach Place, Destin, Fla. 32550

SECURITY: A deposit in the amount of $250 is payable at the time this lease is booked and will be returned by the landlord within two weeks after lease expiration less any damages or excessive cleaning fees. You will be asked to pay the deposit by Credit Card at the end of this online booking process. The balance of rent and any other fees are due 60 days before you arrive. You can mail a check to the owner. This information will be emailed to you. If you are booking this within 60 days of arrival, the total amount is due at time of booking.

Any damage noticed upon arrival should be reported to the owner immediately. If damage is not reported, your deposit may be charged for the cost of the repair. All general maintenance should also be reported so the unit can be kept in good repair. In order to have Deposit returned, the following must occur:
a) No damage is done to the unit or its content including the linens.
b) No items are missing upon the inventory check. (this includes, but is not limited to, transferring items to other units.
c) All debris, garbage and discards are placed in proper containers.
d) All soiled dishes are placed in the dishwasher.
e) There was no exceeding the maximum occupancy of the unit.
f) There was no smoking or evidence of smoking in a designated non-smoking unit.
g) Unit is left in neat condition.

Your deposit will be returned to your credit card within two weeks of your departure if these terms are fulfilled.

SEVERE WEATHER—We do not refund rents or deposits lost due to cancelled or shortened stays because of weather. Departures due to inclement weather do no warrant refund of rent or deposit.

Hurricane Policy and Tropical Storm Policy

We do not offer any refunds for Hurricanes or Tropical Storms. We highly recommend getting TRAVEL Insurance for your trip. It is up to the Rentor to purchase this coverage for their trip.

Coverage is available for health and weather related problems. Please call them direct or order online to purchase this in your name.

Travel Insurance and Hurricanes: What's Covered?

Travel insurance through Travel Guard may cover a traveler's vacation investment if severe weather conditions directly affect their travel arrangements or accommodations. For example, if a traveler is forced to cancel a trip due to a hurricane, travel insurance with trip cancellation can provide a reimbursement for nonrefundable expenses, up to the limit of coverage purchased.

If severe weather forces the evacuation of the traveler's unit, the travel insurance may provide reimbursement for nonrefundable expenses, and additional travel expenses. For losses to be covered, travel insurance must be purchased before a hurricane is forecasted or predicted. Once a storm is named, losses resulting from a hurricane that has been forecasted or predicted on or before the effective date of coverage are excluded.

All claims will be evaluated on their own merits at the time of adjudication.

Travel Insurance is available on this site and we highly recommend you purchase it.

ABSOLUTELY NO PETS are permitted in rental units under any circumstances, NO EXCEPTIONS. If any evidence of a pet(s) is found in your unit or on the premises, you will be asked to vacate immediately with no refund of rent or damage deposit.

COMMUNITY RULES: Rentor agree to abide by rules of the community. These may be posted in the unit or at the community pool or office. These rules may change from time to time.

Minimum Stay: This is a weekly rental. Saturday to Saturday. If you have a question about a longer stay please contact the owner direct.

INCLUSIVE FEES—Rates include a one-time linen setup and cleaning service at the time of departure. There is NO DAILY MAID SERVICE. Rentors will need to provide their own paper items and cleaning supplies. An initial set up of trash liners and toiletries is provided. Extra items needed are the responsibility of the rentor. (i.e. Bring your tooth paste, laundry detergent, soap, beach towels, extra toilet paper etc.)

UTILITIES: The landlord will provide water, heat, electric, trash removal and local telephone usage. RENTOR is responsible for all long distance calls made during tenancy.

RESTRICTIONS: No trailers, boats, jet skis.

ACCOMMODATIONS: One king, one queen, 2 sets of bunk beds and one sleeper sofas. RENTOR supplies linens for beach use.

MAXIMUM NUMBER OF OCCUPANTS: The house is to be occupied by no more than 10 (Ten) persons at a maximum. We will not rent to vacationing students or singles under 25 years of age unless accompanied by an adult guardian or parent. No chaperoned groups VIOLATION OF THIS PROVISION SUBJECTS RENTOR TO SIGNIFICANT PENALTIES WHICH ARE NECESSARY TO PROTECT THE OWNER BECAUSE OF THE FACT THAT THIS LEASE IS A SHORT TERM SUMMER VACATION RENTAL. FALSIFIED RESERVATIONS—Any reservation obtained under false pretense will be subject to forfeiture of advance deposit and/or rental money and the party will not be permitted to check-in.

RENTOR assures the OWNER that the tenants will observe all conditions and terms of this lease as to maintaining the premises in good order and appearance and will conduct themselves in a manner inoffensive to neighbors.

RENTOR assures the OWNER that any tenant who violates any of the terms of this Lease shall be immediately denied occupancy and shall remedy any damages or other expenses, which are caused by the tenant and/or the tenant's rentor(s).

RENTOR agrees that any tenant who is found using drugs or allows others to use drugs on the premises will be immediately denied continued occupancy at these premises.

RENTOR and/or their rentors shall not disturb, annoy, endanger, or inconvenience neighbors, nor use the premises for any immoral or unlawful purposes, nor violate any law or ordnance, nor commit waste or nuisance on or about the premises.

RENTOR agrees that during the term of this lease and such further time as he/she occupies the premises, he/she will keep the leased premises clean and free of trash, garbage, and other waste; and all pipes, wires, glass, plumbing and other equipment and fixtures in the same condition as at the beginning of, or may put in during the term of the lease, reasonable wear and tear and damage by unavoidable fire and casualty only exception.

RENTOR agrees to indemnify and save OWNER harmless from all liability, loss or damage arising from any nuisance or harm made or suffered on the leased premises by the RENTOR, tenants, or rentors or from any carelessness, neglect, or improper conduct of any persons entering, occupying or visiting the leased premises.

RENTOR agrees that he/she shall not paint or make alterations to the property, including changing existing locks or adding new ones, without the OWNER'S written consent.

Upon not less than 24 hours notice, RENTOR shall make available to OWNER or his agent for the premises of entering to make necessary or convenient repairs and to show the premises to prospective tenants. In an emergency, OWNER or his agent may enter the premises at any time without securing prior permission from RENTOR.

RENTOR may not let, sublet or assign this lease for all or any part of the premises without prior consent of the OWNER.

If RENTOR abandons or vacates the premises, OWNER may at his option terminate this lease, enter the premises, and remove all property.

In the event that any action shall be commenced by either party arising out of, or concerning this lease or any right or obligation derived there from, the prevailing party shall be entitled to receive attorney's fees as fixed by the Court in addition to all relief at law or equity.

Either party may terminate this lease in the event of a violation of early provision of this lease by the other party in the manner and as provided by law. The Policies and Procedures above are meant to protect our rentors and owners alike. All rentors, as well as owners are required to conform to all Policies and Procedures. Violators are subject to eviction according to Florida Statute 509.141.

RENTOR assumes full responsibility for fulfilling the terms of the lease for the period stated and assure the OWNER full recourse for the payment of any amount outstanding from the total amount due in accord with the terms as stated above including any outstanding or unpaid charges that are the responsibility of the RENTOR.

In the event of cancellation of this contract, refund of the advanced rental deposit will be made only to the extent that a tenant call be found to occupy the vacated time reserved under this contract.

PENALTY FOR VIOLATING MAXIMUM OCCUPANCY PROVISION. VIOLATION OF THE MAXIMUM OCCUPANCY PROVISION CAN RESULT IN SERIOUS HEALTH PROBLEMS DIRECTLY RELATED TO OVERUSE OF THE SEWER. THEREFORE, IN THE EVENT RENTOR ALLOWS THE PREMISES TO BE OCCUPIED BY MORE THAN TEN PERSONS, RENTOR SHALL BE RESPONSIBLE TO PAY OWNER. THE-SUM OF ONE HUNDRED ($100.00) DOLLARS PER PERSON IN EXCESS OF TEN PERSONS PER DAY FOR EACH DAY THE RENTOR ALLOWS THE PREMISES TO BE OCCUPIED BY MORE THAN TEN, PERSONS.

Cancellation Policy

Cancellation or changes of reservations with advance payments. Cancellations that are made more than (30) days prior to the check in date will forfeit a minimum charge of $50.00. Cancellations that are made within (30) days of the check in date forfeit the full advance payment. Any changes that are made more than thirty (30) days prior to the check in date will not be penalized. Any changes made within (30) days of the check in date that result in a shortened stay, change of dates, change of location or unit, may result in loss of entire advance payment. Cancellations and early departures due to inclement weather do not warrant any refund of rent.

CREDIT CARD AUTHORIZATION: I understand and consent to the use of the credit card provided without original signature on the charge slip, that a photocopy or fax of this agreement will serve as an original, and that this Credit Card Authorization cannot be revoked and will not terminate until 90 days after leased premises are vacated. Charges may include: unauthorized long distance telephone and satellite TV charges; damages beyond normal wear and tear; unreturned keys, parking and water taxi passes.

As noted in the Sample Online Contract of Example 2, travel insurance can be offered by the website of the system. Typically the owner is not responsible if a hurricane hits the rented unit before or during the rentor's stay, or if a serious illness occurs in the rentor's party before or during their vacation. Thus the website can work in conjunction with a travel insurance company which offers the ability to purchase travel insurance on the website. With coverage available for bad weather, unexpected illness of a traveler or family member, plus numerous other allowances, the website can thus offer the ability to customize and purchase insurance while making the reservation. An estimate is typically given before the rentor purchases the insurance.

After the contract associated with the desired vacation rental property is reviewed, the rentor will be directed to agree to the terms and conditions of the contract, and then confirm that the terms and conditions are accepted by clicking on an Acceptance button at the website, as shown in Example 3, below.

### EXAMPLE 3

Sample Acceptance Form

[image]

Payment Information:

PAYMENT 1: $10,000.00 Reservation Deposit is due Dec. 27, 2005. Please submit payment via Credit Card.

Terms And Conditions:

I have read the TERMS OF THE PROPERTY OWNER and agree
I have read the IVACATIONONLINE.COM TERMS and agree Click on button below to be qualified to rent this property:

I Accept all of the Above Terms and Conditions

NOTE: This reservation MUST be confirmed by the owner to be valid! You will receive an Email from the owner confirming your reservation shortly. Thank you!

The booking engine will typically request that the rentor review the information related to the desired vacation rental property, agree to the terms and conditions of the contract, and provide an Acceptance confirming agreement of the terms and conditions of the contract, as described above, before proceeding further. Transfer of information is completed via a secure connection on the website, and submission of an Acceptance by the rentor typically serves as an electronic signature signifying acceptance of the owner's Offer for rental of the specific vacation rental property associated with the selected Listing.

Regarding qualification of the prospective rentor (Step 34), the booking engine typically reviews the information provided in Step 31 by a prospective rentor and then determines if the rentor is permitted to rent the property associated with the selected Listing. If the prospective rentor has satisfactorily performed the steps of selecting at least one of the Listings, completing the application form, selecting the desired dates of stay, reviewing the associated contract, agreeing to the terms and conditions of the contract, and providing an Acceptance of the Offer associated with a selected Listing, the booking engine will approve the rentor as qualified.

Regarding the Status message (Step 36), the message generated by the booking engine typically informs the prospective rentor whether they have been rejected or accepted as a qualified rentor. If rejected, the Status message is a rejection notice to the prospective rentor, indicating that no approval has been given to rent the property associated with the selected Listing. If the booking engine confirms that the prospective rentor is a qualified rentor (i.e. if the rentor has satisfactorily completed the application form and agreed to the terms and conditions associated with the selected Listing), the Status message is an approval notice indicating instant approval as a qualified rentor.

As soon as the rentor is notified of their approval as a qualified rentor, the booking engine has the capacity to complete the transaction by executing a booking without farther input from the owner (Step 38). Owner involvement in the booking process is thus minimized. More specifically, the booking engine typically executes a booking by requesting the qualified rentor, as he views the website interface, to select a form of payment offered by the owner, completing a purchase transaction, and then generating a Notification message to the owner and the rentor providing notification of the booking. Since some owners permit rentors to complete the purchase transaction by paying with a personal check or money order, the booking engine can complete the purchase transaction by arranging payment in this manner. However, the purchase transaction is typically completed immediately at the website interface by processing a credit card belonging to the qualified rentor, and may include services using PayPal, BidPay, Merchant Account, etc. Depending on the terms and conditions of the contract, the purchase transaction includes payment of at least a portion of the rental fee, and also a rental deposit. As a non-limiting example, a request for payment information may as in Example 4, below.

### EXAMPLE 4

Sample Online Payment Questionnaire

[image]

Thus, the booking engine provides a first pass automatic approval system that allows a prospective rentor to choose a desired vacation rental property and receive an approval as a qualified rentor of the selected Listing within seconds. The owner's offer for renting the unit is conditioned on the accuracy of the information provided by the prospective rentor. When the rentor provides an Acceptance, digital signatures or other electronic verification means may be used to verify the authenticity of the prospective rentor's information.

After a unit is booked, the system tracks the dates booked and updates the calendar automatically to display the booking. If a lease is cancelled the calendar will reflect that time frame being open. The system can include a pre-set list of electronic messages, or e-mails, so the owner and rentor may stay in communication throughout the booking process. As a non-limiting example, the system can generate the Status message (Step 36) as an e-mail, or the Notification e-mail (Step 40), both described above. Further, a Cancellation e-mail can be generated notifying both owner and rentor of a cancellation of the contract by one of the parties (Step 44). Another e-mail can notify the rentor that a second payment is due, after payment of the first payment and deposit. Similarly, the system can generate an e-mail to notify the rentor that the lease has been paid in full and then provide Access information to the rentor. Access information is information detailing for the rentor how to physically access the unit, including the check-in time and departure time. Yet another e-mail can be generated after the rentor has returned from their stay, informing the rentor that the deposit is being returned, or else kept due to damage caused, and asking the rentor for a comment on their stay. The system can be time sensitive and recognize when the payments are due and generate the e-mail messages. The system also can remind the owner and rentor when payment is still due.

FIG. 2 also illustrates how the system 10 handles the rental process from the owner's position. Specifically, the transaction proceeds as follows. First the owner subscribes to the website and provides rental property details for each Listing of their vacation rental properties, including a rental schedule with dates and offered rates, to be included in the owner database (Step 30). The owner then waits while the prospective rentor initiates the rental process and becomes a qualified rentor via Steps 31-34 (the prospective rentor's point of view is described in more detail above) and the booking engine automatically books the selected rental property (Step 38). Upon booking the owner's rental property, the booking engine generates a Notification message, typically in the form of an e-mail, which is sent to the owner. If the owner accepts or requires advance payment (e.g. payment via PayPal or a Merchant Account), the rentor is directed to complete the online payment form, and the owner and rentor will then receive an email receipt verifying the payment. However the owner can also allow payment via a personal check or money order. The owner can then respond to the booking by confirming and acknowledging payment, or by refusing payment. As noted above, the owner may, for any reason, cancel the request and refund any advance payments. If the owner accepts the booking he will reply to the Notification message giving approval, thereby causing the website to generate an electronic mail message to the rentor confirming the transaction. After approval and acceptance of a first payment, the booking engine can also generate messages to the owner (and rentor) prior to the rental start date for the rented property, with final details and any payment reminders. If the owner refuses the booking he will reply to the Notification message giving a refusal, thereby causing the website to generate an electronic mail message to the rentor canceling the transaction.

The system is typically programmed to host automated vacation rental property services for multiple owners. Each owner in the system can input their own rental criteria for each rental property they own, which are provided to the prospective rentors in each of the Listings. In one embodiment, the rental criteria are the same for all participating owners. In a preferred embodiment, the rental criteria are customized by each owner. The booking engine allows a prospective rentor to view the Listings and select and book a desired vacation rental property over a secure connection on the Internet. From the convenience of home, prospective rentors can search for and book their desired vacation rental property within a matter of seconds.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A system for conducting an online transaction related to vacation rental property, the system comprising:
a) an owner database including a plurality of Listings, each Listing specific to a vacation rental property and comprising a rental schedule, an Offer and a contract including terms and conditions;
b) a website interface providing a field for the prospective rentor to view the Listings and an application form for a prospective rentor to complete; and
c) a booking engine adapted to receive an Acceptance from the prospective rentor, qualify the prospective rentor, and execute a booking with the qualified rentor.

2. The system of claim 1, wherein the website interface directs the prospective rentor to perform the following steps:
a) view the plurality of Listings;
b) select at least one of the Listings;
c) review the rental schedule and the contract associated with the selected Listing;
d) complete the application form; and
e) provide an Acceptance of the Offer associated with the selected Listing.

3. The system of claim 2, wherein the prospective rentor provides an Acceptance by clicking on an Acceptance button at the website.

4. The system of claim 1, wherein the booking engine qualifies the prospective rentor by confirming that the prospective rentor has satisfactorily completed the application form, has agreed to the terms and conditions associated with the contract of a selected Listing, and has provided an Acceptance.

5. The system of claim 4, wherein the booking engine thereafter generates a message to the qualified rentor at the website interface indicating their status as a qualified rentor.

6. The system of claim 1, wherein the booking engine executes a booking by directing the qualified rentor to select a form of payment offered by the owner, completing a purchase transaction, and generating an electronic mail message to the owner and the rentor providing notification of the booking.

7. The system of claim 6, wherein the owner, upon receiving the electronic mail message providing notification of the booking, has the option to accept or refuse the booking, and, if accepted, causes the website to generate an electronic mail message to the rentor confirming the transaction, and if refused, causes the website to generate an electronic mail message to the rentor canceling the transaction.

8. The system of claim 6, wherein the booking engine completes the purchase transaction at the website interface by processing a credit card of the rentor.

9. A method for an owner of vacation rental property to advertise and rent their property, the method comprising computer-implemented steps for:
a) providing at least one Listing to a website, the website comprising an owner database, a website interface, and a booking engine;
b) receiving an electronic mail message providing notification of a booking of the at least one Listing; and
c) accepting or refusing the booking,
wherein the owner database includes a plurality of Listings, each Listing specific to a vacation rental property and comprising a rental schedule, an Offer and a contract including terms and conditions;
wherein the website interface provides a field for the prospective rentor to view the Listings and an application form for a prospective rentor to complete;
and wherein the booking engine is adapted to receive an Acceptance from the prospective rentor, qualify the prospective rentor, and execute a booking with the qualified rentor.

10. The method of claim 9, wherein the owner accepts the booking by causing the website to generate an electronic mail message to the rentor confirming the transaction.

11. The method of claim 9, wherein the owner refuses the booking by causing the website to generate an electronic mail message to the rentor canceling the transaction.

12. The method of claim 9, wherein the booking engine qualifies the prospective rentor by confirming that the prospective rentor has satisfactorily completed the application form, has agreed to the terms and conditions associated with the contract of a selected Listing, and has provided an Acceptance.

13. The method of claim 9, wherein the booking engine executes a booking by directing the qualified rentor to select a form of payment offered by the owner, completing a purchase transaction, and generating an electronic mail message to the owner and the rentor providing notification of the booking.

14. The method of claim 13, wherein the booking engine completes the purchase transaction at the website interface by processing a credit card of the rentor.

15. A method for a rentor of vacation rental property to book the property, the method comprising computer-implemented steps for:
a) selecting at least one Listing at a website, the website comprising an owner database, a website interface, and a booking engine; and
b) providing an Acceptance to an Offer to book the at least one Listing at the website;
and
c) participating in a booking with the booking engine,
wherein the owner database includes a plurality of Listings, each Listing specific to a vacation rental property and comprising a rental schedule, an Offer and a contract including terms and conditions; wherein the website interface provides a field for the prospective rentor to view the Listings and an application form for the rentor to complete; and wherein the booking engine is adapted to receive the Acceptance from the rentor, qualify the rentor, and execute a booking with the rentor.

16. The method of claim 15, wherein the website interface directs the rentor to perform the following steps:
a) view the plurality of Listings;
b) select at least one of the Listings;
c) review the rental schedule and the contract associated with the selected Listing;
d) complete the application form; and
e) provide an Acceptance of the Offer associated with the selected Listing.

17. The method of claim 16, wherein the rentor provides an Acceptance by clicking on an Acceptance button at the website.

18. The method of claim 15, wherein the booking engine qualifies the rentor by confirming that the rentor has satisfactorily completed the application form, has agreed to the terms and conditions associated with the contract of a selected Listing, and has provided an Acceptance.

19. The method of claim 18, wherein the booking engine thereafter generates a message to the rentor at the website interface indicating their status as a qualified rentor.

20. The method of claim 15, wherein the booking engine executes a booking by directing the rentor to select a form of payment offered by the owner, completing a purchase transaction, and generating an electronic mail message to the owner and the rentor providing notification of the booking.
